(19) United States
(12) Patent Application Publication
(10) Pub. No.: US 2012/0119095 A1
(43) Pub. Date: May 17, 2012

(54) MULTIGRID HIGH PRESSURE GASEOUS PROPORTIONAL SCINTILLATION COUNTER FOR DETECTING IONIZING RADIATION

(76) Inventors: Carlos Alberto Nabais Conde, Coimbra (PT); Filipa Isabel Gouveia De Melo Borges Belo Soares, Coimbra (PT); Sergio José Coelho Do Carmo, Soure (PT); João Carlos Raimundo Mariquito, Abrantes (PT)

(21) Appl. No.: 13/202,618

(22) PCT Filed: Feb. 22, 2010
(86) PCT No.: PCT/PT2010/000007

§ 371 Date: Nov. 29, 2011

(30) Foreign Application Priority Data
Feb. 20, 2009 (PT) PT104417

(51) Int. Cl. G01T 1/205

(52) U.S. Cl. 250/366; 250/361 R

(57) ABSTRACT

The present invention deals with a Multigrid High Pressure Gas Proportional Scintillation Counter for the detection of ionizing radiation such as X-rays, gamma-rays, electrons or other charged leptons, alpha-particles or other charged particles as well as neutrons, which gives information about the energy dissipated in the gas and the time of occurrence of the detection, through an electronic pulse with an amplitude approximately proportional to that energy. It is essentially characterized by:
having external metallic walls (1) at ground potential,
being filled at a pressure in the 1-100 atmosphere range with a pure noble gas and/or continuously purified, or in mixtures,
having: a reflective CsI photocathode (7); four metallic grids: G1 (2), G2 (3), G3 (4) and G4 (5) made of thin wire and with high optical transmission, superior to 70%, defining five regions delimited by these grids (2, 3, 4, 5), by the entrance radiation window (6) and by the photocathode (7),
having the high voltages of the several grids applied through feedthroughs (9), producing appropriate electric fields in the several regions of the detector, that do not vary with the time.

### SCOPE OF THE INVENTION

High pressure, room temperature, xenon based (HPXe) radiation detectors (Aprile 2006) with pure Xe or Xe with added molecular gases (e.g. CF4, CH4, N2) have been the subject of intensive recent research due to their large size capability, relative insensitivity to temperature variations, good energy resolution (2-4% for 662 keV gamma rays, Austin 2007) and relatively low cost. This kind of performance places them somewhere between room temperature semiconductor detectors and inorganic scintillation counters (Knoll 2000). The fields of applications of HPXe detectors range from homeland security (detection of accidental or criminal transport of radioactive sources, IEEE2006), to instrumentation for boreholes in geological prospection and X-ray fluorescence analysis, to pure physics experiments: detection of neutrino and neutrinoless double beta decay of Xe-136 (HPXe TPC in Nygren 2009), gamma ray/hard X-ray polarimetry studies and neutron detection.

There is a niche in the commercial market for room temperature, large area, high efficiency, good energy resolution, gamma ray detectors with a performance superior to that of standard NaI(Tl) scintillation counters (IEEE2006) and a cost much lower than semiconductor detectors, for applications in radiation portals to be deployed in sensitive points like airports, terrestrial borders, harbours, highways and public access buildings. HPXe detectors may meet those needs.

The existing HPXe detectors described in the literature lie along three main types:

i) ionization chambers (Bolotnikov 2004),
ii) proportional ionization counters (Rachinhas 1996),
iii) proportional scintillation counters (Bolozdynya 2004).

While ionization chambers offer the best energy resolution (Austin 2007), they are very sensitive to microphonic noise which degrades the performance in field work. On the other hand, proportional ionization counters are not very stable at high pressures due to the exponential growth of the gain (Rachinhas 1996), and proportional scintillation counters, while being vibration proof, are not ruggedized since they use optical windows, photomultipliers or CsI-coated microstrip plates (Conde 2004).

Noble gas radiation detectors have been the subject of intensive research work by a few teams in Coimbra, for over four decades, namely in the field of the gas proportional scintillation counters (GPSC) for X-rays (for a recent review see (Conde 2004)). However, few researches have been carried out in the field of HPXe detectors for hard X- and gamma rays.

An important characteristic of the proportional scintillation of noble gases and their mixtures with small amounts of molecular gases, is that it can be produced with no electron multiplication (Conde 1977) from a threshold at about 1 V/(cm·Torr) up to about 5 or 6 V/(cm·Torr) yielding a large number of “secondary” scintillation photons, typically 500 per primary ionization electron. Since the statistical fluctuations in the number of secondary scintillation photons are small, the energy resolution is close to the Fano factor limited one.

### SUMMARY OF THE INVENTION

The present invention, which we disclose here, consists in a Multigrid High Pressure Gas Proportional Scintillation Detector (or Counter) (MGHP-GPSC) for ionizing radiation like X-rays, gamma rays, electrons and other charged leptons, alpha particles and other charged particles, as well as neutrons, which gives information about the energy dissipated in the gas and the time of occurrence of the detection, through an electronic pulse with an amplitude approximately proportional to that energy.

It has the great advantage over standard high pressure gas filled ionization chambers (Austin 2007) of being capable of giving pulses with amplitudes at least one order of magnitude larger than ionization chambers, with no or little charge multiplication (proportional ionization counters also give large amplitude pulses but with charge multiplication). It has the great advantage over standard high pressure gas proportional scintillation counters (Bolozdynya 2004) of not requiring the complexity of photomultipliers or other photosensors, nor optical windows. It can have the further advantage of being capable of having the outside walls at ground potential.

### BRIEF DESCRIPTION OF THE FIGURES

FIG. 1 represents the schematic of a Multigrid High Pressure Gas Proportional Scintillation Counter.

FIG. 2 represents a view of the interior of the present prototype of a Multigrid High Pressure Gas Proportional Scintillation Counter.

### DETAILED DESCRIPTION OF THE INVENTION

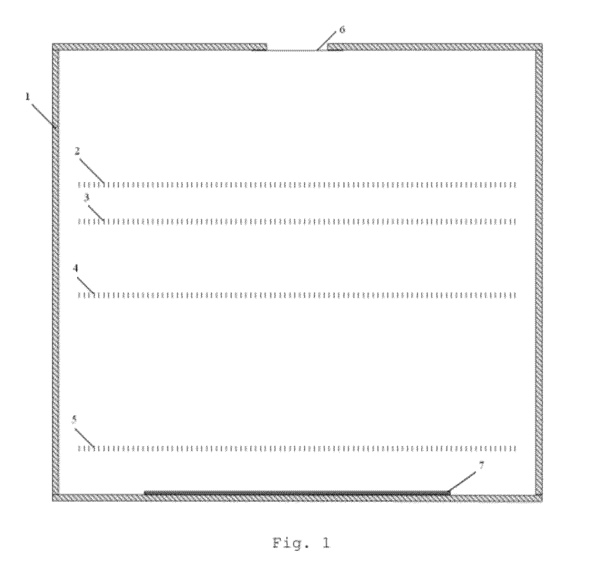

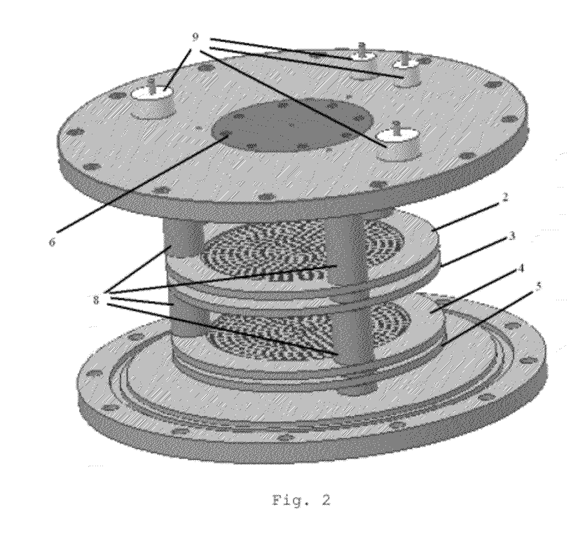

The principles of the invention are better described in a preferred embodiment, represented schematically in FIGS. 1 and 2 and exemplified for the detection of gamma rays.

The detector (FIGS. 1 and 2) has outside metallic walls (1) and four parallel grids inside: G1 (2), G2 (3), G3 (4) e G4 (5) made of thin wire with high optical transmission (70-90%). The grids (2, 3, 4, 5) are circular, framed in a circular metallic frame. The frames with the grids are supported by insulator rods (8) to keep them in the positions required to get the appropriate electric fields in the different regions. The required electric voltages are applied to the grids from the outside of the detector body through high voltage feedthroughs (9) (FIG. 2). The detector is filled with very pure or continuously purified Xenon at the pressure of 1 to 20 atmospheres. With thicker walls, pressures up to 100 atmospheres, or more, can be used provided increased voltages are applied to the grids. The referred to above grids G1 (2), G2 (3), G3 (4) e G4 (5) are made of thin (about 80 micrometer diameter wire) mesh with a pitch of about 1 mesh/mm. The grids (2, 3, 4, 5) are circular, about 10 cm in diameter, framed in a circular 2 mm thick stainless steel frame.

The absorption of the ionizing radiation, or of the particles to detect, takes place in xenon, mainly in the region between the radiation entrance window (6) and the grid G1 (2), denominated as “drift region”, with appropriate length to absorb the radiation. A cloud of primary electrons is originated in this region (about 30,000 primary electrons for a 662 keV gamma photon). The reduced electric field in this region must be lower than the threshold for production of secondary scintillation (about 1 V/(cm Torr for pure xenon).

The primary electrons drift towards the region between grids G1 (2) and G2 (3) (“secondary scintillation region”) where, under the influence of a reduced electric field above the secondary scintillation threshold but not higher than the ionization threshold (about 5 or 6 V/(cm Torr)), they produce a large number of VUV secondary scintillation photons: typically 2000 photons per primary electron drifting across a 20 kV voltage difference between G1 (2) and G2 (3) in Xe (Santos 1994).

In a standard GPSC these photons would be detected by a photomultiplier tube or a CsI-coated microstrip plate, with the drawback that these photosensors are not sufficiently ruggedized for field applications.

The new idea is to let the secondary scintillation VUV photons cross an “optical transmission region” delimited by grids G2 (3) and G3 (4) followed by an “electric field barrier region” delimited by grids G3 (4) and G4 (5), before they reach a reflective CsI photocathode (7). The electric field in the “optical transmission region” does not allow the primary electrons to cross it, and therefore these primary electrons are collected in the grid G2 (3). The VUV photons also cross the “photoelectron collection region” which is a region delimited by the grid G4 (5) and the photocathode (7), before they reach the CsI photocathode (7). The electric field in the “photoelectron collection region” has an intensity which is below the threshold for secondary scintillation, so that it does not allow secondary scintillation production (avoiding thus optical positive feedback) but guarantees a photoelectron extraction efficiency as good as possible, which can reach values of about 5% per incident VUV photon (Dias 2004). Assuming that a fraction of at least 10% of the secondary scintillation VUV photons reaches the photocathode (7) due to solid angle and grid transmission effects, the number of photoelectrons emitted from the about 500 nm thick, vacuum evaporated CsI photocathode (7), will be at least 10 per primary electron. These photoelectrons are collected in G4 (5), due to the electric field barrier established by G3 (4) and G4 (5) voltages (G3 (4) voltage lower than G4 (5) voltage). The electron charge signal in G4 (5) is then amplified by the electronic amplification stages and produces a pulse with a measurable amplitude nearly proportional to the energy dissipated in the gas drift region.

In conclusion, since it is expected to collect in G4 (5) at least 10 photoelectrons per primary ionization electron, the charge signal from this proposed GPSC design will be at least 10 times larger, and so a lot less sensitive to noise, than the signal from a standard HPXe ionization chamber. However, by working at pressures of 40 atm of xenon, with a reduced electric field of 5 V/(cm Torr) in a 1 cm thick “secondary scintillation region” and with solid angles subtended by the photocathode (7) of 30%, gains of about 200 photoelectrons collected in G4 (5) per primary electron are possible to be reached. Also, since charge multiplication is almost excluded, the instabilities and signal fluctuations associated with proportional ionization counters are avoided (Rachinhas 1996). Furthermore, no optical windows are necessary, resulting in a ruggedized detector that can be made with large areas and volumes.

Due to the expected increase in the signal-to-noise ratio, we predict energy resolutions with the MGHP-GPSC closer to the R=0.5% intrinsic limit than the 2% value reported in (Austin 2007) for 662 keV in Xe using an ionization chamber (intrinsic FWHM energy resolution: R=2.35\sqrt{Fw/E} assuming a Fano factor F=0.17 and w=22 eV (do Carmo 2008)).

Very recently, a preliminary MGHP-GPSC (published in (Borges 2009)) was designed, built and tested by the inventors in our laboratory using alpha particles. The preliminary results obtained agree with the expected ones as far as the pulse amplitudes vary with the electric fields in the different detector regions. A gain of 10 photoelectrons per primary electron has already been experimentally reached by the inventors (Borges 2009).

The detector can be filled with other noble gases at high pressure or with mixtures of noble gases in various proportions, or with mixtures of noble gases with molecular gases such as N₂, H₂, CH₄ or CF₄ in proportions that do not reduce the production of secondary scintillation, or that even reducing it, allow us to obtain electronic pulses larger than the ones obtained with a ionization chamber with the same gases or with gaseous mixtures with He-4 for the detection of fast neutrons or with He-4 and/or He-3 for the detection of fast and slow neutrons.

Other reflective photocathodes (7) can additionally be used like KI, KBr or others with a work function for the extraction of electrons lower than the energy of the secondary scintillation photons, together with a vacuum quantum efficiency not much lower than 1% for the secondary scintillation photons of the gases or gaseous mixtures used.

The referred to above photocathodes (7) can also be segmented such that by getting the output signals from each photocathode segment, rather than from grid G4 (5), and by using Anger camera type techniques, information about the two dimensional position of the radiation track can be obtained. For these cases the electric field barrier region and so grid G3 (4) can be eliminated. Each segmented photocathode can be hexagonal, square, rectangular, or circular in shape, with sizes of the order of the photocathode (7) to grid G2 (3) distances. These segmented photocathodes (7) are closely packed, so to substantially cover the back side of the detector. Each segmented photocathode (7) has its own pulse processing electronics channel.

By having the radiation entrance window (6) electrically isolated from the detector body and biased at negative high voltage it is possible to eliminate the optical transmission region and so grid G3 (4), by biasing grid G1 (2) with negative high voltage, lower in module than the voltage of the window (6), and still have electric fields in the other regions appropriate, i.e. below the threshold for secondary scintillation and pointing to the window (6) in the drift region, higher than the threshold for secondary scintillation and below the threshold for ionization and pointing to grid G1 (2) in the secondary scintillation region, below the threshold for secondary scintillation and pointing to grid G2 (3) in the electric field barrier, and below the threshold for secondary scintillation and pointing to the photocathode (7) in the photoelectron collection region, which implies that the voltage applied to G2 (3) must-be lower than the voltage applied to G4 (5) so that the photoelectrons are still collected in G4 (5).

For the case where the signal is taken from grid G2 (3) or from the photocathodes (7) (single or segmented), both grids G3 (4) and G4 (5) can be eliminated provided the electric field between the photocathodes (7) and the grid G2 (3) is below the threshold for secondary scintillation, pointing to the photocathode (7) and the ripple of the voltage applied to grid G2 (3) is low enough so it does not interfere with the photocathode signal.

The plate(s) that support(s) the photocathode (7) or the segmented photocathodes can be separated from the lower external wall of the detector, so that the deformation of the same wall due to the high pressure of the gas inside will not affect the parallelism between the grids (2,3,4,5) and the photocathode (7) or segmented photocathodes, and so the uniformity of the electric field in the photoelectron collection region.

Due to the finite dimensions of the photocathode (7) that emits the photoelectrons resulting from the secondary scintillation produced between the grids G1 (2) and G2 (3), the amplitude of the signal collected in G4 (5) decreases radially, because of solid angle effects, with the radial coordinate of the point of absorption of the radiation. This amplitude variation leads to a degradation of the energy resolution. Such amplitude variation can be compensated by two ways as explained in a previous patent (Conde 1996):

i) by increasing radially the intensity of the secondary scintillation produced between G1 (2) and G2 (3), i.e. the number of produced photons, by using a curved grid G1 (2) and/or a curved grid G2 (3), in order to reduce radially the distance between the points of G1 (2) and G2 (3) and so increase radially the electric field between the grids G1 (2) and G2 (3), in a way so to compensate the radially decreasing fraction of the VUV secondary scintillation light reaching the photocathode due to solid angle effects.

ii) by increasing radially the detection efficiency of the secondary scintillation photons impinging on the photocathode (7) in order to keep constant the number of photoelectrons emitted from the photocathode (7), by using either masks with radially decreasing transmission covering the photocathode or photocathodes (7) with radially increasing efficiency. The photocathodes with radially increasing efficiency can be produced by making them out of a large number of small photocathode dots, say 1 mm in diameter each dot, with the density of dots increasing radially in a way so to compensate the radially decreasing amount of the VUV secondary scintillation light (produced between the parallel grids G1 (2) and G2 (3)) reaching the photocathode due to solid angle effects. Such a dot pattern can be produced by covering the photocathode plane during the CsI evaporation stage with a mask with holes in the place where photocathode dots should be.

### REFERENCES

Aprile 2006—“Noble Gas Detectors” E. Aprile, A. E. Bolotnikov, A. I. Bolozdynya and T. Doke, WILEY-VCH Verlag GmbH & Co. KGaA, Weinheim (2006).
Austin 2007—“High-pressure xenon detector development at Constellation Technology Corporation” R. A. Austin, Nucl. Instrum. Meth. A 579 (2007) 58-61.
Bolotnikov 2004—“Dual-Anode High-Pressure Xenon Cylindrical Ionization Chamber” A. Bolotnikov, A. Bolozdynya, R. DeVito, J. Richards, IEEE Trans. Nucl. Sci. 51 (2004) 1262-1269
Bolozdynya 2004—“Vibration-proof High-pressure Xenon Electroluminescence Detector” A. Bolozdynya and R. De Vito “2003 IEEE Nuclear Science Symposium Conference Record” Vol. 1-5 (2004) 648-650 and “Vibration-proof High-pressure Xenon Electroluminescence Detector” A. Bolozdynya and R. DeVito, IEEE Trans. Nucl. Sci. 51-3 (2004) 931-933.
Borges 2009—“A new technique for gaseous gamma ray detectors: the multigrid high pressure xenon gas proportional scintillation counter”, Conference Record of the IEEE NSS-MIC2009 (2009) 713-716.
Conde 1977—“Secondary scintillation output of xenon in a uniform-field gas proportional scintillation counter” C. A. N. Conde, L. R. Ferreira and M. F. A. Ferreira, IEEE Trans. Nucl. Sci. 24 (1977) 221-224.
Conde 1996—“Gas proportional scintillation counter for ionizing radiation with medium and large size radiation windows and/or detection volumes”, C. A. N. Conde, J. M. F. dos Santos and A. C. S. S. M. Bento, U.S. Pat. No. 5,517,030, May 14, 1996.
Conde 2004—“Gas Proportional Scintillation Counters for X-ray Spectrometry” C. A. N. Conde, Chapter 4.2 in the book “X-Ray Spectrometry: Recent Technological Advances” edited by K. Tsuji, J. Injuk and R. Van Grieken (2004) John Wiley & Sons, 195-215.
Dias 2004—“The transmission of photoelectrons emitted from CsI photocathodes into Xe, Ar, Ne and their mixtures: a Monte Carlo study of the dependence on E/N and incident VUV photon energy” T. H. V. T. Dias, P. J. B. M. Rachinhas, J. A. M. Lopes, F. P. Santos, L. M. N. Távora, C. A. N. Conde and A. D. Stauffer, J. Phys. D: Appl. Phys. 37 (2004) 540-549.
DoCarmo 2008—“Experimental study of the w-values and Fano factors of gaseous xenon and Ar—Xe mixtures for X-rays” S. J. C. do Carmo, F. I. G. M. Borges, F. L. R. Vinagre, and C. A. N. Conde, IEEE Trans. Nucl. Sci. 55 (2008) 2637-2642.
dos Santos 1994—“The Performance of a Compact Gas Proportional Scintillation Counter for Hard X-rays Spectrometry” J. M. F. dos Santos, J. F. C. A. Veloso, R. E. Morgado and C. A. N. Conde, Nucl. Instrum. Meth. A 353 (1994) 195-200.
IEEE2006—“IEEE/ANSI N42 Radiation Detection™ standards program”.
Knoll 2000—“Radiation Detection and Measurement”, G. F. Knoll, John Wiley & Sons, New York (2000), 3d. Edition.
Nygren 2009—“High-pressure Xenon Gas Electroluminescent TPC for 0-neutrino beta beta-decay Search” D. R. Nygren, Nucl. Instrum. Meth. A603 (2009) 337-348.
Rachinhas 1996—“Energy resolution of xenon proportional counters: Monte Carlo simulation and experimental results” P. J. B. M. Rachinhas, T. H. V. T. Dias, A. D. Stauffer, F. P. Santos and C. A. N. Conde, IEEE Trans. Nucl. Sci. 43-4 (1996) 2399-2405.
Lisbon, 18 Mar. 2010

1. A Multigrid High Pressure Gas Proportional Scintillation Counter for the detection of ionizing radiation which gives information about the energy dissipated in a gas and the time of occurrence of the detection, through an electronic pulse with an amplitude approximately proportional to that energy, comprising:
a detector having metallic outside walls at ground potential, said detector being filled at a pressure in the 1-100 atmosphere range with a noble gas pure and/or continuously purified, or in a mixture;
a reflective CsI photocathode within said detector;
four grids within said detector made of thin wire and with high optical transmission, not inferior to 70%, wherein said four grids define five regions delimited thereby, namely: a drift region delimited by a radiation entrance window and a first grid, a secondary scintillation region delimited by the first grid and a second grid, an optical transmission region delimited by the second grid and a third grid, an electric field barrier region delimited by the third grid and a fourth grid, and a photoelectron collection region delimited by the fourth grid and a photocathode;
wherein the high voltages of said grids are applied through feedthroughs, thereby producing electric fields in said regions that do not vary in time;
wherein a series of pulses is emitted whose amplitude is superior, by a factor 2 to 200, to that provided by ionization chambers, without almost no charge multiplication;
wherein an output electronic pulse proportional to an average number of photoelectrons emitted by an active area of the photocathode directly in contact with the gas, which are collected in said fourth grid is amplified by a standard electronic pulse amplifier;
wherein the following reduced electric fields are applied in the different regions, when the detector is filled with gas: below the threshold for secondary scintillation and pointing to the radiation entrance window in the drift region, above the threshold for secondary scintillation and below the threshold for ionization and pointing to the second grid in the secondary scintillation region, below the threshold for secondary scintillation in both the optical transmission and electric field barrier regions with both electric fields pointing to the third grid, and below the threshold for secondary scintillation and pointing to the photocathode in the photoelectron collection region, which implies that the voltage in the third grid is lower than the voltage in the fourth grid so that the photoelectrons are collected in the fourth grid.

2. The Gas Proportional Scintillation Counter according to claim 1 wherein said metallic outside walls comprise stainless steel at least 2 mm thick.

3. The Gas Proportional Scintillation Counter according to claim 1 wherein said grids comprise wires with approximately 80 micrometers in diameter, with a pitch of approximately one wire per mm, and with an optical transmission of about 70 or 90%.

4. The Gas Proportional Scintillation Counter according to claim 1 wherein said detector is filled with pressurized xenon, pure or continuously purified.

5. The Gas Proportional Scintillation Counter according to claim 1 wherein said grids are each circular with about 10 cm in diameter, mounted in a 2 mm thick stainless steel circular frame, with the frames with the grids are supported by insulator rods to keep them in the positions required to get the appropriate electric fields in the different regions.

6. The Gas Proportional Scintillation Counter according to claim 1 wherein said detector is filled at high pressures with noble gases comprising krypton, argon, neon, helium, or mixtures of these noble gases in various proportions, or mixtures of noble gases with molecular gases like N₂, H₂, CH₄ or CF₄ in proportions that do not reduce significantly or even increase the secondary scintillation yield or that, even reducing it, enable the production of electronic pulses larger than the ones obtained with ionization chambers filled with the same gases.

7. The Gas Proportional Scintillation Counter according to claim 1 wherein said detector is filled with gas mixtures with He-4 for fast neutron detection and He-4 and/or He-3 isotopes for fast and slow neutron detection.

8. The Gas Proportional Scintillation Counter according to claim 1 wherein said detector comprises reflective photocathodes with photoelectron extraction work functions lower than the energy of the secondary scintillation photons, together with a vacuum quantum efficiency, not much less than 1%, for the secondary scintillation photons of the gas or gaseous mixture used.

9. The Gas Proportional Scintillation Counter according to claim 1 wherein said detector comprises segmented photocathodes such that by getting the output signals from each photocathode segment, rather than from the fourth grid, and by using Anger camera type techniques, information about the two dimensional position of the radiation track can be obtained and such as to allow the electric field barrier region and the third grid to be eliminated.

10. The Gas Proportional Scintillation Counter according to claim 1 wherein said detector comprises either hexagonal, square, rectangular, or circular in shape segmented photocathodes, with sizes of the order of the photocathode to the second grid distances and by having these segmented photocathodes closely packed, to substantially cover the back side of the detector, and having their own pulse processing electronics channel.

11. The Gas Proportional Scintillation Counter according to claim 1 wherein the radiation entrance window is electrically isolated from the detector body and biased at negative high voltage so that it is possible to eliminate the optical transmission region and the third grid, by biasing the first grid with negative high voltage, lower in module than the voltage of the window, and still have electric fields in the other regions appropriate, i.e. below the threshold for secondary scintillation and pointing to the window in the drift region, above the threshold for secondary scintillation and below the threshold for ionization and pointing to the first grid in the secondary scintillation region, below the threshold for scintillation and pointing to the second grid in the electric field barrier, and below the threshold for secondary scintillation and pointing to the photocathode in the photoelectron collection region, which implies that the voltage applied to the second grid to be lower than the voltage applied to the fourth grid so that the photoelectrons are still collected in the fourth grid.

12. The Gas Proportional Scintillation Counter according to claim 11 wherein, for the case where the signal is taken from the second grid or from the photocathodes, not having the third and fourth grids G3, provided the electric field between the photocathodes and the second grid is below the threshold for secondary scintillation and pointing to the photocathode and the ripple of the voltage applied to the second grid is low enough so it does not interfere with the collected signal.

13. The Gas Proportional Scintillation Counter according to claim 1 wherein the plate(s) that support(s) the photocathode or the segmented photocathodes are separated from the lower external wall of the detector, so that the deformation of the same wall due to the high pressure of the gas inside, will not affect the parallelism between the grids and the photocathode or segmented photocathodes, and so the uniformity of the electric field in the photoelectron collection region.

14. The Gas Proportional Scintillation Counter according to claim 1, wherein the decreasing amplitude of the output signal is compensated with the radial coordinate of the point of absorption of the radiation, this decreasing being due to solid angle effects that result from the finite dimensions of the photocathode that emits the photoelectrons resulting from the secondary scintillation produced between the first and second grids, reducing thus the degradation of the energy resolution by:
i) radially increasing the intensity of the secondary scintillation produced between the first and second grids by using a curved first grid and/or a curved second grid, in order to reduce radially the distance between the points of the first grid and the second grid and so increasing radially the electric field between the first and second grids, in a way so to compensate the radially decreasing fraction of the VUV secondary scintillation light reaching the photocathode due to solid angle effects, or
ii) increasing radially the detection efficiency of the secondary scintillation photons impinging on the photocathode in order to keep constant the number of photoelectrons emitted from the photocathode, by using either masks with radially decreasing transmission covering the photocathode or with radially increasing efficiency, the photocathodes with radially increasing efficiency can be produced by making them out of a large number of small photocathode dots, with the density of dots increasing radially in a way so to compensate for the radially decreasing amount of the VUV secondary scintillation light produced between the parallel first and second grids reaching the photocathode due to solid angle effects.
